(19) United States
(12) Patent Application Publication
(10) Pub. No.: US 2026/0347600 A1
(43) Pub. Date: Nov. 5, 2026

(54) PHONOGRAPH RECORDS

(71) Applicant: COLLOIDS LIMITED, Merseyside (GB)

(72) Inventors: Graham Cotton, Kirkby, Merseyside (GB); Sophie Jeffs, Kirkby, Merseyside (GB)

(73) Assignee: Colloids Limited, Kirkby, Merseyside, EN (GB)

(21) Appl. No.: 19/115,485

(22) PCT Filed: Sep. 26, 2023
(86) PCT No.: PCT/GB2023/052493

§ 371 Date: Mar. 26, 2025

(30) Foreign Application Priority Data
Sep. 26, 2022 (GB) 2214001.6

(51) Int. Cl. C08L 67/04; C08K 3/04; G11B 3/70

(52) U.S. Cl. CPC C08L 67/04; C08K 3/042; G11B 3/705; C08L 2201/06

(57) ABSTRACT

A phonograph record is formed, at least partially, from a bioplastic, namely, polylactic acid (PLA), in an admixture with either, or both of, grapheme or graphite. The preferred composition is:

| | |
|---|---|
| PLA Biopolymer | 87-98% |
| Sugar Starch Wax | 0.25-5% |
| Single Layer and Multi-Layer Graphene | 0.1-3% |
| Colorant | 2-5%. |

### FIELD OF THE INVENTION

The invention relates to phonograph records.

### BACKGROUND TO THE INVENTION

Current phonograph records/discs are made of PVC (polyvinyl chloride), often with added dyes, lubricants and stabilisers. Attempts have been made to reduce the dependency on PVC by using two different materials in such a way that PVC is used only for the groove area while a cheaper material is used for the inner groove-free area of the disc.

Another proposal is to replace part of the expensive raw material with cheap fillers. The addition of such fillers, however, leads to surface noise and thus to a reduction in quality, which is no longer acceptable due to the increased demands on playback quality.

### STATEMENTS OF THE INVENTION

According to the present invention, there is provided a phonograph record formed at least partially from a bioplastic, that is to say, a plastics material derived from biological substances rather than from petroleum, many types of which are biodegradable.

An example of a suitable plastics material is PLA (polylactic acid).

Preferably, the bioplastic is in admixture with graphene or graphite.

Preferably, the bioplastic is modified with one or more of an inert filler and an impact modifier.

The presence of graphene and/or graphite will reduce significantly the build up of static, improving scratch resistance and rigidity. In addition, the graphene permits the records to be thinner pressings, thereby reducing the amount of material needed.

Overall, the use of phonograph records of the invention will improve the environmental impact for the music industry.

### DETAILED DESCRIPTION OF THE INVENTION

A phonograph record in accordance with the present invention may have the following composition:

| | |
|---|---|
| PLA biopolymer | 87-98% |
| Sugar starch wax | 0.25-5% |
| Single layer and multi-layer graphene | 0.1-3% |
| Carbon black colourant | 2-5% |

The upper limit for the PLA biopolymer may be, for instance, 97.65%.

The black colourant may be substituted by other colourants according to the desired aesthetic effect.

The components are admixed using conventional equipment including twin screw extrusion to form a fully compounded material.

1-10. (canceled)

11. A phonograph record formed at least partially from a bioplastic comprising polylactic acid (PLA) in admixture with at least one of graphene and graphite.

12. The phonograph record according to claim 11, wherein said bioplastic is modified with at least one of an inert filler and an impact modifier.

13. The phonograph record according to claim 11, wherein said bioplastic is in the admixture with sugar starch wax.

14. A composition for making a phonograph record, comprising:
a bioplastic including polylactic acid (PLA); and,
at least one of graphene and graphite.

15. The composition for making a phonograph record according to claim 14, further comprising sugar starch wax.

16. The composition for making a phonograph record according to claim 14, further comprising a carbon black colorant.

17. The composition for making a phonograph record according to claim 14, comprising:
PLA Biopolymer 87-98%
Sugar Starch Wax 0.25-5%
Single Layer and Multi-Layer Graphene 0.1-3%
Colorant 2-5%.

18. The composition for making a phonograph record according to claim 17, wherein said colorant is a carbon black colorant.
